(19) United States
(12) Patent Application Publication
(10) Pub. No.: US 2023/0072334 A1
(43) Pub. Date: Mar. 9, 2023

(54) LEARNING METHOD, COMPUTER PROGRAM PRODUCT, AND LEARNING APPARATUS

(71) Applicant: KABUSHIKI KAISHA TOSHIBA, Tokyo (JP)

(72) Inventor: Yushiro KASHIMOTO, Yokohama Kanagawa (JP)

(73) Assignee: KABUSHIKI KAISHA TOSHIBA, Tokyo (JP)

(21) Appl. No.: 17/651,961

(22) Filed: Feb. 22, 2022

(30) Foreign Application Priority Data
Sep. 8, 2021 (JP) 2021-145941

(51) Int. Cl. G06N 3/08; G06N 3/063; G06N 3/04; G06K 9/62

(52) U.S. Cl. CPC G06N 3/08; G06N 3/063; G06N 3/04; G06K 9/6256

(57) ABSTRACT

According to an embodiment, a learning method is to be performed by a computer. The learning method includes performing learning of a neural network so as to reduce a value of a first loss function representing a correlation between channels in feature vectors output from at least one of intermediate layers and a final layer in the neural network to which a plurality of pieces of training data has been input.

### CROSS-REFERENCE TO RELATED APPLICATIONS

This application is based upon and claims the benefit of priority from Japanese Patent Application No. 2021-145941, filed on Sep. 8, 2021; the entire contents of which are incorporated herein by reference.

### FIELD

Embodiments described herein relate generally to a learning method, a computer program product, and a learning apparatus.

### BACKGROUND

Learning of a neural network with learning data has been performed. For example, disclosed has been a method of performing adversarial learning to prevent discrimination between feature vectors of a supervised training data set and feature vectors of an unsupervised training data set (e.g., WO 2021/038812 A). In addition, disclosed has been a method for learning with, as a loss function, the covariance between elements in the feature vectors of supervised training data (e.g., refer to Michael Cogswell, et al. “Reducing Overfitting in Deep Networks by Decorrelating Representations”).

However, according to the method in WO 2021/038812 A, learning is performed such that discriminable information is forcibly made indiscriminable by adversarial learning, and thus, in some cases, a task at which a learning model originally aims is adversely affected. According to the method in Michael Cogswell, et al. “Reducing Overfitting in Deep Networks by Decorrelating Representations”, use of the covariance between elements for a loss function in supervised learning reduces the variance of elements, resulting in a reduction in the representation of feature vectors, in some cases. That is, according to the conventional techniques, in some cases, the performance of neural networks deteriorates.

### BRIEF DESCRIPTION OF THE DRAWINGS

FIG. 1 is a block diagram of an exemplary configuration of a learning apparatus;

FIG. 2A is an explanatory diagram of exemplary learning processing;

FIG. 2B is a schematic view of exemplary feature vectors;

FIG. 3A is an explanatory diagram of exemplary learning processing of a neural network;

FIG. 3B is an explanatory diagram of exemplary learning processing of the neural network;

FIG. 3C is an explanatory diagram of exemplary learning processing of the neural network;

FIG. 4 is a schematic view of an exemplary display screen;

FIG. 5 is a flowchart of an exemplary flow of information processing; and

FIG. 6 illustrates a hardware configuration.

### DETAILED DESCRIPTION

According to an embodiment, a learning method is to be performed by a computer. The learning method includes performing learning of a neural network so as to reduce a value of a first loss function representing a correlation between channels in feature vectors output from at least one of intermediate layers and a final layer in the neural network to which a plurality of pieces of training data has been input.

A learning method, a learning program, and a learning apparatus will be described in detail below with reference to the accompanying drawings.

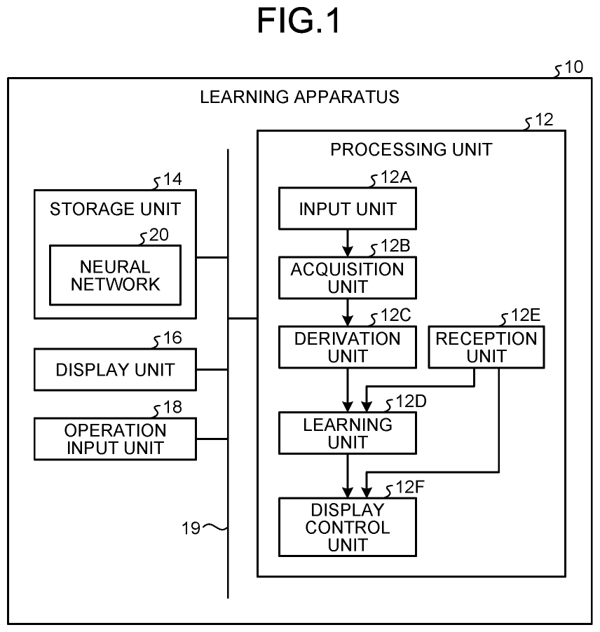

FIG. 1 is a block diagram of an exemplary configuration of a learning apparatus 10 according to the present embodiment.

The learning apparatus 10 serves as an information processing apparatus that performs learning of a neural network 20.

The learning apparatus 10 includes a processing unit 12, a storage unit 14, a display unit 16, and an operation input unit 18. The processing unit 12, the storage unit 14, the display unit 16, and the operation input unit 18 are connected through a bus 19, enabling data or signals to be transmitted or received.

The storage unit 14 stores various types of data.

Examples of the storage unit 14 include semiconductor memory elements, such as a random access memory (RAM) and a flash memory, a hard disk, and an optical disc. Note that the storage unit 14 may be a storage device provided outside the learning apparatus 10. At least one of a plurality of functional units included in the storage unit 14, the display unit 16, the operation input unit 18, and the processing unit 12 may be mounted on an external information processing apparatus connected communicably to the learning apparatus 10, for example, through a network.

The display unit 16 serves as a display that displays various types of information. The operation input unit 18 receives an operation input from a user. Examples of the operation input unit 18 include various types of pointing devices, such as a mouse, and a keyboard. Provided may be a touch panel in which the display unit 16 and the operation input unit 18 are integrally formed.

The processing unit 12 performs information processing including learning processing in which the neural network 20 learns.

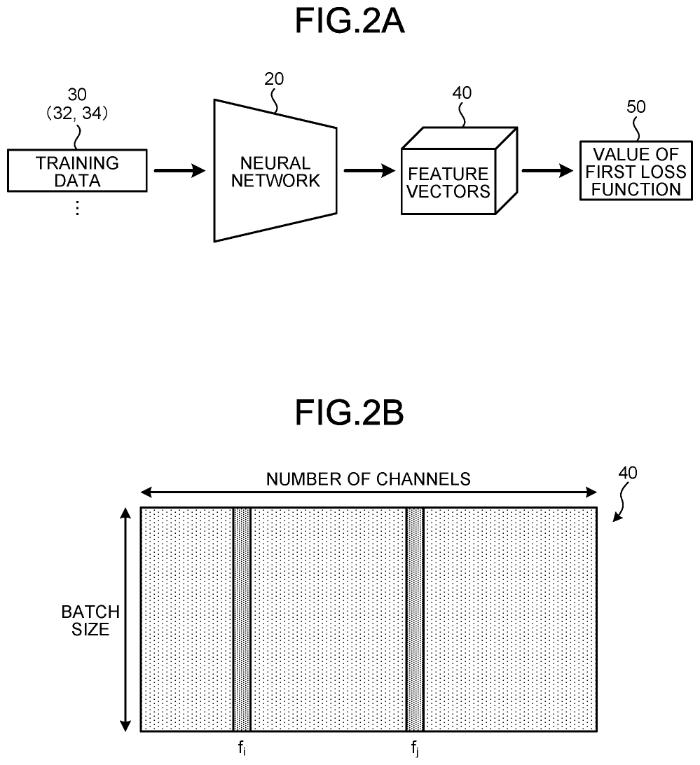

FIG. 2A is an explanatory diagram of exemplary learning processing by the processing unit 12.

The processing unit 12 performs learning the neural network 20 so as to reduce a value 50 of a first loss function obtained from the correlation between channels in feature vectors 40 output from at least one of intermediate layers and a final layer in the neural network 20 having a plurality of pieces of training data 30 input thereto.

The training data 30 serves as input data to be used in learning of the neural network 20. For example, a plurality of pieces of training data 30 to be input to the neural network 20 includes a supervised training data set 32 and an unsupervised training data set 34.

The supervised training data set 32 includes a plurality of pieces of supervised training data given annotation information. The unsupervised training data set 34 includes a plurality of pieces of unsupervised training data given no annotation information.

The annotation information is data representing, directly or indirectly, correct data that should be output from the neural network 20 in learning. The annotation information is also referred to as a ground truth label.

The training data 30 input to the neural network 20 is processed in accordance with a parameter in a model of the neural network 20, so that the feature vectors 40 is output as an array from the intermediate layer or final layer in the neural network 20.

Note that the processing unit 12 may perform, to the feature vectors 40, an operation in the form of the array or an operation in the value of the array based on a particular axis. Examples of such operations include operation techniques for reducing the number of dimensions of an array, such as “Global Average Pooling” and “Global Max Pooling”.

FIG. 2B is a schematic view of exemplary feature vectors 40.

In FIG. 2B, the horizontal axis represents the number of channels. The vertical axis represents batch size. A channel is a type of element representing feature vectors. Examples of such a type of element include, in a case where the training data 30 corresponds to person's face image data, the distance between both eyes and the level of the nose on the face. Note that the above is not limiting and thus, in practice, some variables effective in identifying an individual from a face image, extracted as numerical values due to learning of a neural network, require using as elements. For example, the number of channels is 256, but this number is not limiting.

The batch size corresponds to the number of samples of training data 30. That is, the batch size corresponds to the number of pieces of training data 30 used in learning of the neural network 20.

The value 50 of the first loss function represents the level of correlation between channels in the feature vectors 40. For example, the processing unit 12 specifies the values fᵢ and fⱼ of arbitrary two channels in the feature vectors 40. fᵢ and fⱼ each are a group of values of the feature vectors of the plurality of pieces of training data 30 in one of channels different from each other and each are represented by a vector. For example, the value 50 of the first loss function is calculated with a correlation coefficient. For example, the value 50 of the first loss function means the correlation coefficient r_{i, j} between the values fᵢ and fⱼ of the two channels. i and j are integers each representing the ordinal number of the channel and differ mutually in value. Thus, the correlation coefficient r_{i, j} means the correlation coefficient between the i-th channel and the j-th channel.

Note that, for the value 50 of the first loss function, the absolute sum of the correlation coefficient r_{i, j} or the square sum of the correlation coefficient r_{i, j} requires using.

The processing unit 12 performs learning of the neural network 20 so as to reduce the value 50 of the first loss function. That is, the processing unit 12 performs learning of the neural network 20 so as to reduce the inter-vector correlation between the value fᵢ of the i-th channel and the value fⱼ of the j-th channel, each being represented by a vector.

Particularly, the processing unit 12 calculates the value 50 the first loss function of each of a plurality of combinations resulting from variations in the combination of the i-th channel and the j-th channel, and performs learning of the neural network 20 so as to reduce the value 50 of the first loss function.

Specifically, for example, the processing unit 12 calculates, with a loss function, the value 50 of the first loss function representing the level of correlation between channels, and then performs backpropagation thereof to the neural network 20. For example, the processing unit 12 performs learning of the neural network 20, with addition of the loss given by Expression (1) with the correlation coefficient r_{i,j} between the values fᵢ and fⱼ of the two channels.

$${L}_{r} = {\sum }_{i \neq j} {r}_{i , j}^{2} \qquad ( 1 )$$

Then, the processing unit 12 updates, with a gradient descent method, the parameter in the model of the neural network 20 and performs learning to reduce the value 50 of the first loss function that is the correlation between channels in the feature vectors 40.

The processing unit 12 repeatedly performs learning of the neural network 20 so as to reduce the value 50 of the first loss function, so that a reduction can be made in the correlation between channels in the feature vectors 40. That is, the processing unit 12 can perform learning of the neural network 20 such that information in which the values of channels mutually different in the feature vectors 40 are more different can be represented. Thus, the processing unit 12 can make an improvement in the representation of the feature vectors 40.

Referring back to FIG. 1, more description will be given. The processing by the processing unit 12 will be specifically described.

In the present embodiment, the processing unit 12 includes an input unit 12A, an acquisition unit 12B, a derivation unit 12C, a learning unit 12D, a reception unit 12E, and a display control unit 12F.

The input unit 12A, the acquisition unit 12B, the derivation unit 12C, the learning unit 12D, the reception unit 12E, and the display control unit 12F are achieved, for example, by a single processor or a plurality of processors. For example, each unit above may be achieved by execution of a program by a processor, such as a central processing unit (CPU) or a graphics processing unit (GPU), namely, may be achieved by software. Each unit above may be achieved by a processor, such as a dedicated IC, namely may be achieved by hardware. Each unit above may be achieved by a combination of software and hardware. In a case where a plurality of processors is used, each processor may achieve any one of the units or any two or more of the units.

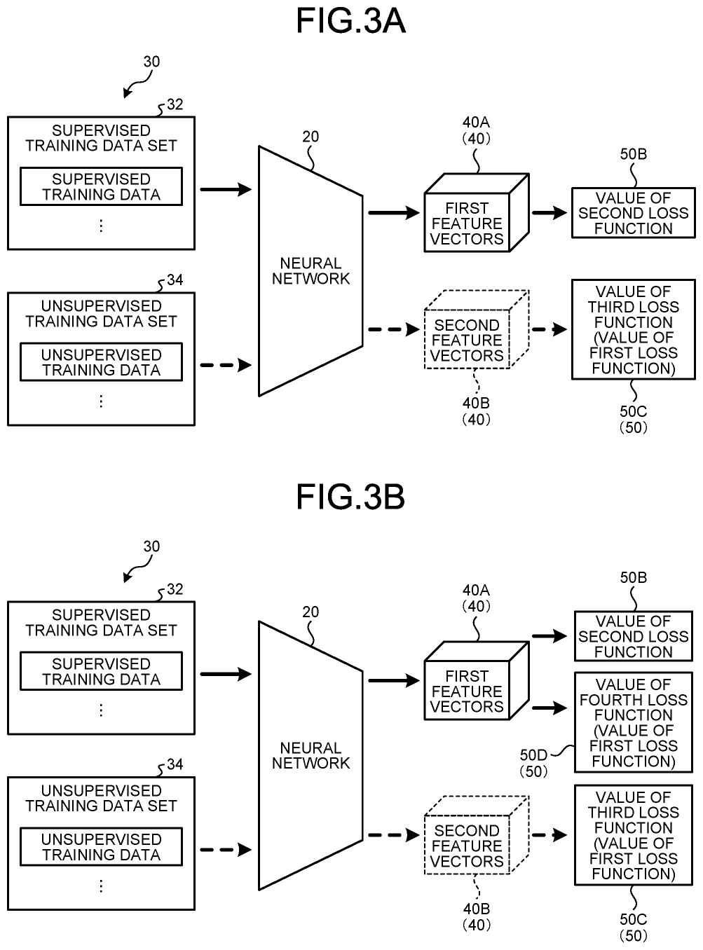

FIG. 3A is an explanatory diagram of exemplary learning processing of the neural network 20.

The input unit 12A inputs a plurality of pieces of training data 30 to the neural network 20.

For example, the input unit 12A inputs, to the neural network 20, the supervised training data set 32 and the unsupervised training data set 34 as a plurality of pieces of training data 30.

Note that, as a plurality of pieces of training data 30 to be input to the neural network 20, a group of a plurality of supervised training data sets 32 and a group of a plurality of unsupervised training data sets 34 may be used.

In this case, the plurality of supervised training data sets 32 may differ mutually in domain. Difference in domain means difference in at least one of the type of data and the environment of acquisition of data. Specifically, for example, supervised training data sets 32 differing mutually in domain are a supervised training data set 32 for scenery and a supervised training data set 32 including person image data.

Similarly, the plurality of unsupervised training data sets 34 may be pieces of training data 30 differing mutually in domain.

As the unsupervised training data set 34, used may be a data set including the supervised training data set 32 excluding the annotation information.

The input unit 12A may input, to the neural network 20, partial supervised training data included in the supervised training data set 32. Alternatively, the input unit 12A may input, to the neural network 20, all the supervised training data included in the supervised training data set 32.

Similarly, the input unit 12A may input, to the neural network 20, partial unsupervised training data included in the unsupervised training data set 34. Alternatively, the input unit 12A may input, to the neural network 20, all the unsupervised training data included in the unsupervised training data set 34.

The acquisition unit 12B acquires, as the feature vectors 40, first feature vectors 40A and second feature vectors 40B.

The first feature vectors 40A correspond to the feature vectors 40 output from at least one of the intermediate layers and the final layer in the neural network 20 by inputting the supervised training data set 32 to the neural network 20.

The second feature vectors 40B correspond to the feature vectors 40 output from at least one of the intermediate layers and the final layer in the neural network 20 by inputting the unsupervised training data set 34 to the neural network 20.

The acquisition unit 12B acquires the first feature vectors 40A from the neural network 20 by inputting the supervised training data set 32 to the neural network 20. The acquisition unit 12B acquires the second feature vectors 40B from the neural network 20 by inputting the unsupervised training data set 34 to the neural network 20.

The order in which the acquisition unit 12B acquires the first feature vectors 40A and the second feature vectors 40B is not limited. For example, the acquisition unit 12B may acquire the second feature vectors 40B after acquiring the first feature vectors 40A. Alternatively, the acquisition unit 12B may acquire the first feature vectors 40A after acquiring the second feature vectors 40B.

As described above, the first feature vectors 40A and the second feature vectors 40B each correspond to the feature vectors 40 output from the intermediate layer or the final layer in the neural network 20. The first feature vectors 40A and the second feature vectors 40B may be the feature vectors 40 that have been output from the mutually different layers in the neural network 20. Alternatively, the first feature vectors 40A and the second feature vectors 40B may be the feature vectors 40 that have been output from the same layer in the neural network 20.

The number of first feature vectors 40A and the number of second feature vectors 40B to be output from the neural network 20 may be each one or more. In a case where each number is two or more, for example, the acquisition unit 12B may acquire, as the corresponding first feature vectors 40A or second feature vectors 40B, a plurality of feature vectors 40 obtained one-to-one from two or more layers in the neural network 20.

The derivation unit 12C derives the value 50 of the first loss function from the feature vectors 40.

For example, the derivation unit 12C derives a value 50B of a second loss function, on the basis of the first feature vectors 40A.

The value 50B of the second loss function corresponds to a value representing how far the output information obtained from the neural network 20 by inputting the supervised training data set 32 to the neural network 20 is from the ideal output state obtained from the annotation information given to the supervised training data set 32. In other words, the value 50B of the second loss function corresponds to information representing how close or far the output information output from the neural network 20 is from the annotation information given to the supervised training data set 32.

The output information represents, directly or indirectly, output data output from the neural network 20. In other words, the output information corresponds to information that the neural network 20 outputs as a result of inference with respect to the supervised training data set 32, by inputting the supervised training data set 32 to the neural network 20. Particularly, the output information corresponds to data regarding a task at which the neural network 20 aims, output from the neural network 20.

Examples of the task at which the neural network 20 aims include classification of input data, identification of the input data, generation of different data from the input data, and detection of a particular pattern from the input data. The input data corresponds to data input to the neural network 20. At the learning stage of the neural network 20, the input data corresponds to the training data 30.

The derivation unit 12C derives the output information depending on the task as the aim on the basis of the first feature vectors 40A and derives the value 50B of the second loss function between the derived output information and the annotation information. Note that the value 50B of the second loss function may be calculated with a correlation coefficient.

The derivation unit 12C derives a value 50C of a third loss function, on the basis of the second feature vectors 40B. The value 50C of the third loss function is an example of the value 50 of the first loss function. The derivation unit 12C derives, as the value 50C of the third loss function, the value 50 of the first loss function representing the correlation between channels in the second feature vectors 40B.

The learning unit 12D performs learning of the neural network 20 so as to reduce the value 50B of the second loss function and the value 50C of the third loss function.

Particularly, the learning unit 12D performs backpropagation of the value 50B of the second loss function to the neural network 20 and updates, with the gradient descent method, the parameter in the model of the neural network 20, to achieve learning. Due to such learning, the learning unit 12D performs learning of the neural network 20 so as to improve the performance to the task as the aim.

In this case, the learning unit 12D may use, for calculation of the value 50B of the second loss function regarding the task as the aim, an output obtained due to further input of an intermediate output or a final output from the neural network 20 to another neural network, such as a classifier or a decoder. Then, the learning unit 12D may perform learning of the neural network 20, simultaneously with learning of such another neural network.

The learning unit 12D performs backpropagation of the value 50C of the third loss function that is an example of the value 50 of the first loss function to the neural network 20 and updates, with the gradient descent method, the parameter in the model of the neural network 20, to achieve learning. Due to such processing, the learning unit 12D can perform learning of the neural network 20 so as to improve the representation of the second feature vectors 40B obtained by inputting the unsupervised training data set 34 and so as to improve the performance in the task as the aim.

Note that the loss function used for the value 50C of the third loss function derived from the second feature vectors 40B may include not only a loss function representing the level of correlation between channels but also another type of loss function. In this case, with those types of loss functions for the value 50C of the third loss function, the learning unit 12D may perform learning of the neural network 20. For backpropagation to the neural network 20 with the plurality of types of loss functions for the value 50C of the third loss function, the learning unit 12D may perform individual backpropagation of each type of loss function. Alternatively, the learning unit 12D may perform backpropagation to the neural network 20 with the plurality of types of loss functions for the value 50C of the third loss function integrated by weighted summation.

The learning unit 12D repeatedly performs learning of the neural network 20 so as to reduce the value 50B of the second loss function and the value 50C of the third loss function, so that the neural network 20 can learn the task as the aim. The learning unit 12D can improve the performance of the neural network 20 with the task applied to the unsupervised training data set 34.

Note that FIG. 3A exemplifies that the derivation unit 12C derives, on the basis of the first feature vectors 40A, the value 50B of the second loss function as a value representing how far the output information obtained from the neural network 20 by inputting the supervised training data set 32 to the neural network 20 is from the ideal output state obtained from the annotation information given to the supervised training data set 32. However, the derivation unit 12C may derive, on the basis of the first feature vectors 40A, a value of the fourth loss function as the value 50 of the first loss function representing the correlation between channels in the first feature vectors 40A. Then, with the value 50D of the fourth loss function in addition to the value 50B of the second loss function, the learning unit 12D may perform learning of the neural network 20 so as to reduce the value 50D of the fourth loss function and the value 50C of the third loss function.

FIG. 3B is an explanatory diagram of exemplary learning processing of the neural network 20. FIG. 3B illustrates a mode in which the value 50B of the second loss function, the value 50D of the fourth loss function, and the value 50C of the third loss function are used in learning of the neural network 20.

Similarly to FIG. 3A, the input unit 12A inputs, to the neural network 20, the supervised training data set 32 and the unsupervised training data set 34 as a plurality of pieces of training data 30. Note that, similarly to the above, the input unit 12A may use, as the training data 30, two or more supervised training data sets 32 and two or more unsupervised training data sets 34.

The acquisition unit 12B acquires, as the feature vectors 40, the first feature vectors 40A and the second feature vectors 40B from the neural network 20. The acquisition unit 12B acquires the first feature vectors 40A from the neural network 20 by inputting the supervised training data set 32 to the neural network 20. The acquisition unit 12B acquires the second feature vectors 40B from the neural network 20 by inputting the unsupervised training data set 34 to the neural network 20.

The derivation unit 12C derives the value 50B of the second loss function and the value 50D of the fourth loss function from the first feature vectors 40A and derives the value 50C of the third loss function from the second feature vectors 40B. The value 50D of the fourth loss function is an example of the value 50 of the first loss function. The derivation unit 12C may derive, as the value 50D of the fourth loss function, the value 50 of the first loss function representing the correlation between channels in the first feature vectors 40A.

In this case, the learning unit 12D performs learning of the neural network 20 so as to reduce the value 50B of the second loss function, the value 50D of the fourth loss function, and the value 50C of the third loss function. Particularly, the learning unit 12D performs, to the neural network 20, backpropagation of each of the value 50B of the second loss function, the value 50D of the fourth loss function that is an example of the value 50 of the first loss function, and the value 50C of the third loss function, and updates, with the gradient descent method, the parameter in the model of the neural network 20, to achieve learning. Due to such learning, the learning unit 12D can perform learning of the neural network 20 so as to improve the representation of each of the first feature vectors 40A and the second feature vectors 40B and so as to improve the performance in the task as the aim.

That is, the learning unit 12D repeatedly performs learning of the neural network 20 so as to reduce the value 50B of the second loss function, the value 50D of the fourth loss function, and the value 50C of the third loss function, so that the neural network 20 can learn the task as the aim and an improvement can be made in the performance of the neural network 20 with the task applied to the unsupervised training data set 34.

Note that, without the unsupervised training data set 34 but only with the supervised training data set 32, the processing unit 12 may perform learning of the neural network 20.

FIG. 3C is an explanatory diagram of exemplary learning processing of the neural network 20. FIG. 3C illustrates a mode in which only the supervised training data set 32 is used as the training data 30.

In this case, the input unit 12A inputs, to the neural network 20, the supervised training data set 32 as a plurality of pieces of training data 30. Note that the input unit 12A may use two or more supervised training data sets 32 as the training data 30.

The acquisition unit 12B acquires, as the feature vectors 40, the first feature vectors 40A from the neural network 20. The acquisition unit 12B acquires the first feature vectors 40A from the neural network 20 by inputting the supervised training data set 32 to the neural network 20.

The derivation unit 12C derives the value 50B of the second loss function and the value 50D of the fourth loss function from the first feature vectors 40A. As described above, the value 50B of the second loss function corresponds to a value representing how far the output information obtained from the neural network 20 by inputting the supervised training data set 32 to the neural network 20 is from the ideal output state obtained from the annotation information given to the supervised training data set 32. As described above, the value 50D of the fourth loss function corresponds to the value 50 of the first loss function representing the correlation between channels in the first feature vectors 40A.

In this case, the learning unit 12D performs learning of the neural network 20 so as to reduce the value 50B of the second loss function and the value 50D of the fourth loss function.

Particularly, the learning unit 12D performs backpropagation of the value 50B of the second loss function to the neural network 20 and updates, with the gradient descent method, the parameter in the model of the neural network 20, to achieve learning. Due to such learning, the learning unit 12D performs learning of the neural network 20 so as to improve the performance to the task as the aim. In this case, the learning unit 12D may use, for calculation of the value 50B of the second loss function regarding the task as the aim, an output obtained due to further input of an intermediate output or a final output from the neural network 20 to another neural network, such as a classifier or a decoder. Then, the learning unit 12D may perform learning of the neural network 20, simultaneously with learning of such another neural network.

The learning unit 12D performs backpropagation of the value 50D of the fourth loss function to the neural network 20 and updates, with the gradient descent method, the parameter in the model of the neural network 20, to achieve learning. Due to such learning, the learning unit 12D can perform learning of the neural network 20 so as to improve the representation of the feature vectors 40 output from the neural network 20 and so as to improve the performance to the task as the aim.

That is, the learning unit 12D repeatedly performs learning of the neural network 20 so as to reduce the value 50B of the second loss function and the value 50D of the fourth loss function, so that an improvement can be made in the performance of the neural network 20 to the task as the aim.

Note that, when performing backpropagation of the value 50B of the second loss function and the value 50D of the fourth loss function based on a plurality of loss functions, the learning unit 12D may perform individual backpropagation of each loss function or may perform backpropagation of the plurality of loss functions integrated by weighted summation.

Referring back to FIG. 1, more description will be given. The reception unit 12E receives an instruction operation from the user through the operation input unit 18. In the present embodiment, the reception unit 12E receives an input of a learning condition. The learning condition includes at least one of the network structure of the neural network 20 as the target of learing, the training data 30 to be used in learning, and the content of settings to be used at the time of learning.

For example, while visually checking a display screen displayed on the display unit 16, the user operates the operation input unit 18 to input the learning condition.

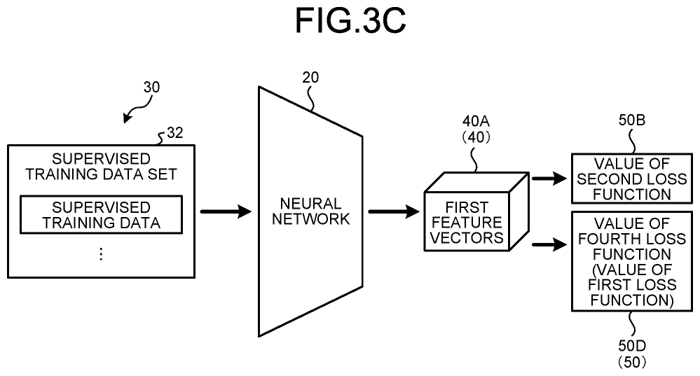

FIG. 4 is a schematic view of an exemplary display screen 60. For example, the display screen 60 includes a selection area 60A for the network structure, a selection area 60B for the supervised training data set 32, a selection area 60C for the unsupervised training data set 34, an input area 60D for parameters, a learning-state display area 60E, a termination button 60F, and a save button 60G.

The selection area 60A for the network structure corresponds to a selection area for the network structure of the neural network 20 as the target of learning. The user selects a desired network structure from a list of network structures displayed in the selection area 60A for the network structure. Due to such selection processing, the user inputs the network structure of the neural network 20 as the target of learning.

The selection area 60B for the supervised training data set 32 corresponds to a selection area for the supervised training data set 32 to be used in learning. The user selects a desired supervised training data set 32 from a list of supervised training data sets 32 displayed in the selection area 60B for the supervised training data set 32.

Due to such selection processing, the user inputs the supervised training data set 32 to be used in learning.

The selection area 60C for the unsupervised training data set 34 corresponds to a selection area for the unsupervised training data set 34 to be used in learning. The user selects a desired unsupervised training data set 34 from a list of unsupervised training data sets 34 displayed in the selection area 60C for the unsupervised training data set 34. Due to such selection processing, the user inputs the unsupervised training data set 34 to be used in learning.

The input area 60D for parameters corresponds to an input field for the content of settings to be used at the time of learning of the neural network 20. For example, the content of settings includes a weighting value for use in integration of a plurality of loss functions and a parameter for use in backpropagation. The user inputs a desired parameter to the input area 60D for parameters, to input the content of settings to be used at the time of learning of the neural network 20.

The learning-state display area 60E corresponds to a display field for the learning state of the neural network 20.

The termination button 60F corresponds to an operation button for issuing an instruction for learning termination. The save button 60G corresponds to an operation button for inputting an instruction for saving the neural network 20 in learning.

The reception unit 12E receives the learning condition input through each of the selection area 60A for the network structure, the selection area 60B for the supervised training data set 32, the selection area 60C for the unsupervised training data set 34, and the input area 60D for parameters.

When the reception unit 12E receives the learning condition, the learning unit 12D may perform learning of the neural network 20 in accordance with the received learning condition.

For example, the learning unit 12D uses, as the training data 30, the supervised training data set 32 and the unsupervised training data set 34 included in the received learning condition. The learning unit 12D uses, as the target of learning, the neural network 20 having the network structure input through the selection area 60A for the network structure. With the content of settings to be used at the time of learning, input through the input area 60D for parameters, the learning unit 12D performs learning of the neural network 20.

The user inputs the learning condition through the display screen 60. In accordance with the learning condition, the learning unit 12D performs learning of the neural network 20. Thus, even if the user lacks sufficient technical knowledge, the user can input the learning condition for the neural network 20, easily. In accordance with the desired learning condition from the user, the learning unit 12D can perform learning of the neural network 20.

The display control unit 12F displays, on the display screen 60, at least one of the learning progress state of the neural network 20 by the learning unit 12D and the content of change recommendation for the learning condition depending on the learning progress state.

For example, the display control unit 12F displays, in the learning-state display area 60E of the display screen 60, the learning progress state of the neural network 20 by the learning unit 12D. Through visual checking of the learning-state display area 60E, the user can check the learning state of the neural network 20, easily.

The content of change recommendation for the learning condition corresponds to information representing the content of change recommended for the learning condition. For example, assumed is a case where, according to the learning progress state, the display control unit 12F determines that the value of the loss function has not reached the threshold as the criterion for learning termination. In this case, the display control unit 12F displays, on the display screen 60, information representing a recommendation for an increase in the volume of the training data 30. Assumed is a case where, according to the learning progress state, the display control unit 12F determines that the value of the loss function has not reached the threshold as the criterion for learning termination. In this case, the display control unit 12F displays, on the display screen 60, information representing a recommendation for a change in the parameter of the neural network 20. Such values of the loss function mean the value 50 of the first loss function, the value 50B of the second loss function, the value 50C of the third loss function, or the value 50D of the fourth loss function described above.

In accordance with the presented content of change recommendation, the user may change the learning condition. Thus, even if the user lacks sufficient technical knowledge, the user can change the learning condition for the neural network 20, easily.

Next, an exemplary flow of information processing to be performed in the learning apparatus 10 according to the present embodiment will be described.

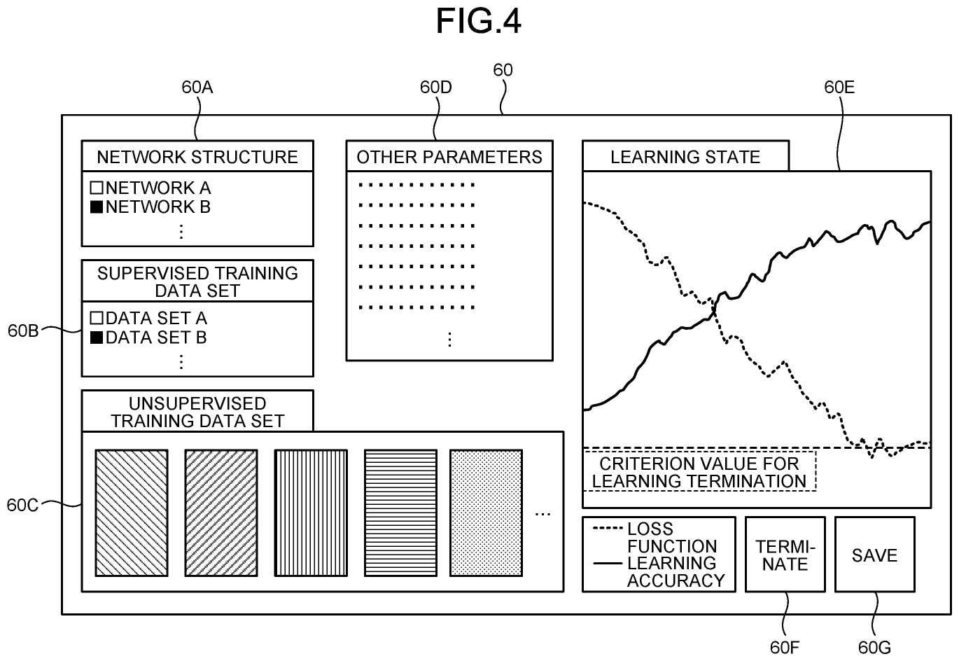

FIG. 5 is a flowchart of the exemplary flow of information processing to be performed in the learning apparatus 10 according to the present embodiment. The exemplary flow of information processing in FIG. 5 corresponds to the learning processing illustrated in FIG. 3A.

The input unit 12A inputs a plurality of pieces of training data 30 to the neural network 20 (Step S100).

The acquisition unit 12B acquires, as the feature vectors 40, the first feature vectors 40A and the second feature vectors 40B output from at least one of the intermediate layers and the final layer in the neural network 20 (Step 102).

The derivation unit 12C derives the value 50 of the first loss function from the first feature vectors 40A and the second feature vectors 40B acquired in Step S102 (Step S104). For example, the derivation unit 12C derives the value 50B of the second loss function from the first feature vectors 40A and derives the value 50C of the third loss function from the second feature vectors 40B.

The learning unit 12D performs learning of the neural network 20 so as to reduce the value 50B of the second loss function and the value 50C of the third loss function derived in Step S104 (Step S106).

Next, the processing unit 12 determines whether or not the learning is to be terminated (Step S108). For determination in Step S108, for example, the processing unit 12 determines whether or not each of the value 50B of the second loss function and the value 50C of the third loss function derived in Step S104 is not more than the threshold as the criterion for learning termination. Alternatively, for determination in Step S108, the processing unit 12 may determine whether or not the termination button 60F has been instruction-operated due to an instruction operation from the user through the operation input unit 18.

If a negative determination is made in Step S108 (Step S108: No), the processing goes back to Step S100 above. If an affirmative determination is made in Step S108 (Step S108: Yes), the neural network 20 having learned is stored in the storage unit 14, then the present routine terminates.

As described above, the learning method according to the present embodiment includes performing learning of the neural network 20 so as to reduce the value 50 of the first loss function representing the correlation between channels in the feature vectors 40 output from at least one of the intermediate layers and the final layer in the neural network 20 having a plurality of pieces of training data 30 input thereto.

A higher correlation between channels in the feature vectors 40 obtained by inputting the training data 30 to the neural network 20 corresponds to more overlap in information represented by the channels. Thus, the representation of the feature vectors 40 is lower with a higher correlation between channels in the feature vectors 40 than with a lower correlation therebetween. Specifically, for example, in a case where the task at which the neural network 20 aims corresponds to data identification with the feature vectors 40, a higher correlation between channels in the feature vectors 40 is unfavorable.

Meanwhile, the learning method to be performed in the learning apparatus 10 according to the present embodiment includes performs learning of the neural network 20 so as to reduce the value 50 of the first loss function between channels in the feature vectors 40. Thus, the learning method according to the present embodiment enables an improvement in the representation of the feature vectors 40.

That is, the learning method according to the present embodiment includes reducing the correlation between channels in the feature vectors 40 without reducing the variance of the values of channels in the feature vectors 40, so that an improvement can be made in the representation of the feature vectors 40.

Therefore, the learning method according to the present embodiment enables an improvement in the performance of the neural network 20.

Note that, as the training data 30 to be input to the neural network 20, favorably, used is data identical in domain to the input data to be used in the destination of application of the neural network 20.

The training data 30 and the input data to be used in the destination of application are likely to differ in domain, such as the environment of acquisition of data or the type of data. In such a case, the performance of inference with the neural network 20 is likely to deteriorate. Meanwhile, with, as the training data 30, data identical in domain to the input data to be used in the destination of application, the learning method according to the present embodiment enables an improvement in the representation of the feature vectors 40 to the input data to be used in the destination of application. In this case, no annotation information is required in calculating and reducing the correlation between channels in the feature vectors 40. Thus, in this case, the learning method according to the present embodiment enables easy provision of the neural network 20 usable in the destination of application with unsupervised input data, in addition to the above effect.

As described above, the value 50 of the first loss function may be calculated with a correlation coefficient.

Use of a correlation coefficient for the value 50 of the first loss function reduces the correlation between channels in the feature vectors 40 without reducing the variance of the values of channels in the feature vectors 40. Thus, the neural network 20 can learn so as to further improve the representation of the feature vectors 40. Such a correlation coefficient has the range of from −1 to 1, regardless of the distribution of original values, and thus no individual normalization is required.

As described with FIGS. 3A and 3B, in the learning method according to the present embodiment, the supervised training data set 32 and the unsupervised training data set 34 may be used as the training data 30. Use of the supervised training data set 32 and the unsupervised training data set 34 as the training data 30 enables to perform learning of the neural network 20 so as to improve the representation to both of the supervised training data set 32 and the unsupervised training data set 34. Thus, the learning method according to the present embodiment enables an improvement in the versatile performance of the neural network 20, in addition to the above effect.

As described above, as the training data 30, used may be a plurality of supervised training data sets 32 and a plurality of unsupervised training data sets 34. Use of a plurality of supervised training data sets 32 and a plurality of unsupervised training data sets 34 enables a further improvement in the performance of the neural network 20, in addition to the above effect.

Next, an exemplary hardware configuration of the learning apparatus 10 according to the present embodiment will be described.

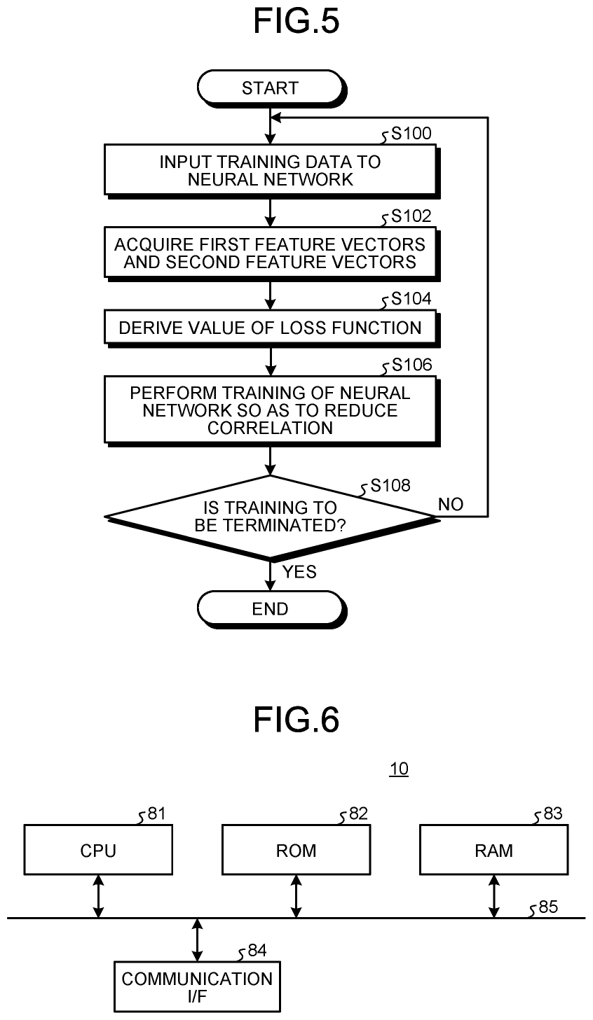

FIG. 6 illustrates the exemplary hardware configuration of the learning apparatus 10 according to the present embodiment.

The learning apparatus 10 according to the present embodiment includes a central processing unit (CPU) 81, a read only memory (ROM) 82, a random access memory (RAM) 83, and a communication I/F 84 that are mutually connected through a bus 85, achieving a hardware configuration based on a general-purpose computer.

The CPU 81 serves as an arithmetic logic unit that controls the learning apparatus 10 according to the present embodiment. The ROM 82 stores, for example, a program that achieves various types of processing by the CPU 81. Although the CPU has been given herein for description, a graphics processing unit (GPU) may be used as the arithmetic logic unit that controls the learning apparatus 10. The RAM 83 stores data necessary for the various types of processing by the CPU 81. The communication I/F 84 serves as an interface that is connected to, for example, the display unit 16 and the operation input unit 18 and transmits or receives data.

In the learning apparatus 10 according to the present embodiment, the CPU 81 reads and executes the program from the ROM 82 onto the RAM 83, so that each function above is achieved on the computer.

Note that the program for performing each piece of processing above to be performed in the learning apparatus 10 according to the present embodiment may be stored in a hard disk drive (HDD). The program for performing each piece of processing above to be performed in the learning apparatus 10 according to the present embodiment may be in advance incorporated in the ROM 82, for provision.

The program for performing the processing above to be performed in the learning apparatus 10 according to the present embodiment may be stored, in the form of an installable file or in the form of an executable file, into a computer-readable storage medium, such as a CD-ROM, a CD-R, a memory card, a digital versatile disc (DVD), a flexible disk (FD), for provision as a computer program product. The program for performing the processing above to be performed in the learning apparatus 10 according to the present embodiment may be stored in a computer connected to a network, such as the Internet, and may be provided by downloading through the network. The program for performing the processing above to be performed in the learning apparatus 10 according to the present embodiment may be provided or distributed through a network, such as the Internet.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A learning method to be performed by a computer, the learning method comprising
performing learning of a neural network so as to reduce a value of a first loss function representing a correlation between channels in feature vectors output from at least one of intermediate layers and a final layer in the neural network to which a plurality of pieces of training data has been input.

2. The method according to claim 1, further comprising:
inputting a supervised training data set and an unsupervised training data set to the neural network as the plurality of pieces of training data, the supervised training data set including a plurality of pieces of supervised training data given annotation information, the unsupervised training data set including a plurality of pieces of unsupervised training data not given the annotation information;
acquiring first feature vectors and second feature vectors, the first feature vectors being the feature vectors output from the neural network by inputting the supervised training data set, the second feature vectors being feature vectors output from the neural network by inputting the unsupervised training data set; and
deriving a value of a second loss function and a value of a third loss function, the value of the second loss function being derived based on the first feature vector and representing a correlation between the annotation information given to the supervised training data set and output information obtained from the neural network by inputting the supervised training data set, the output information corresponding to the annotation information, the value of the third loss function being a value of the first loss function representing a correlation between channels in the second feature vectors, wherein
at the performing the learning, the learning of the neural network is performed so as to reduce the value of the second loss function and the value of the third loss function.

3. The method according to claim 1, further comprising:
inputting a supervised training data set and an unsupervised training data set to the neural network as the plurality of pieces of training data, the supervised training data set including a plurality of pieces of supervised training data given annotation information, the unsupervised training data set including a plurality of pieces of unsupervised training data not given the annotation information;
acquiring first feature vectors that are the feature vectors output from the neural network by inputting the supervised training data set and a second feature vectors that are the feature vectors output from the neural network by inputting the unsupervised training data set; and
deriving a value of a second loss function, a value of a fourth loss function, and a value of a third loss function, the value of a second loss function being derived based on the first feature vectors and representing a correlation between the annotation information given to the supervised training data set and output information obtained from the neural network by inputting the supervised training data set, the output information corresponding to the annotation information, the value of the fourth loss function being a value of the first loss function representing a correlation between channels in the first feature vectors, the value of the third loss function being a value of the first loss function representing a correlation between channels in the second feature vectors, wherein
at the performing the learning, the learning of the neural network is performed so as to reduce the value of the second loss function, the value of the third loss function, and the value of the fourth loss function.

4. The method according to claim 1, further comprising:
inputting a supervised training data set to the neural network as the plurality of pieces of training data, the supervised training data set including a plurality of pieces of supervised training data given annotation information;
acquiring first feature vectors that are the feature vectors output from the neural network by inputting the supervised training data set; and
deriving a value of a second loss function and a value of a fourth loss function, the value of the second loss function being derived based on the first feature vectors and representing a correlation between the annotation information given to the supervised training data set and output information obtained from the neural network by inputting the supervised training data set, the output information corresponding to the annotation information, the value of the fourth loss function being a value of the first loss function representing a correlation between channels in the first feature vectors, wherein
at the performing the learning, the learning of the neural network is performed so as to reduce the value of second loss function and the value of fourth loss function.

5. The method according to claim 1, wherein a correlation coefficient is used for calculation of the value of the first loss function.

6. The method according to claim 1, wherein the plurality of pieces of training data includes a plurality of groups each including a plurality of supervised training data sets and a plurality of groups each including a plurality of unsupervised training data sets.

7. The method according to claim 1, further comprising
receiving an input of a learning condition including at least one of a network structure of the neural network as a target of the learning, the training data to be used in the learning, and a description of setting to be used at a time of the learning, wherein
at the performing the learning, the learning of the neural network is performed in accordance with the learning condition having been received.

8. The method according to claim 7, further comprising
displaying a display screen including at least one of a learning progress state of the neural network and a content of change recommendation for the learning condition depending on the learning progress state.

9. A computer program product comprising a computer-readable medium including programmed instructions, the instructions causing a computer to execute:
performing learning of a neural network so as to reduce a value of a first loss function representing a correlation between channels in feature vectors output from at least one of intermediate layers and a final layer in the neural network to which a plurality of pieces of training data has been input.

10. The computer program product to claim 9, further comprising:
inputting a supervised training data set and an unsupervised training data set to the neural network as the plurality of pieces of training data, the supervised training data set including a plurality of pieces of supervised training data given annotation information, the unsupervised training data set including a plurality of pieces of unsupervised training data not given the annotation information;
acquiring first feature vectors and second feature vectors, the first feature vectors being the feature vectors output from the neural network by inputting the supervised training data set, the second feature vectors being feature vectors output from the neural network by inputting the unsupervised training data set; and
deriving a value of a second loss function and a value of a third loss function, the value of the second loss function being derived based on the first feature vector and representing a correlation between the annotation information given to the supervised training data set and output information obtained from the neural network by inputting the supervised training data set, the output information corresponding to the annotation information, the value of the third loss function being a value of the first loss function representing a correlation between channels in the second feature vectors, wherein
at the performing the learning, the learning of the neural network is performed so as to reduce the value of the second loss function and the value of the third loss function.

11. The computer program product to claim 9, further comprising:
inputting a supervised training data set and un unsupervised training data set to the neural network as the plurality of pieces of training data, the supervised training data set including a plurality of pieces of supervised training data given annotation information, the unsupervised training data set including a plurality of pieces of unsupervised training data not given the annotation information;
acquiring first feature vectors that are the feature vectors output from the neural network by inputting the supervised training data set and a second feature vectors that are the feature vectors output from the neural network by inputting the unsupervised training data set; and
deriving a value of a second loss function, a value of a fourth loss function, and a value of a third loss function, the value of a second loss function being derived based on the first feature vectors and representing a correlation between the annotation information given to the supervised training data set and output information obtained from the neural network by inputting the supervised training data set, the output information corresponding to the annotation information, the value of the fourth loss function being a value of the first loss function representing a correlation between channels in the first feature vectors, the value of the third loss function being a value of the first loss function representing a correlation between channels in the second feature vectors, wherein
at the performing the learning, the learning of the neural network is performed so as to reduce the value of the second loss function, the value of the third loss function, and the value of the fourth loss function.

12. The computer program product to claim 9, further comprising:
inputting a supervised training data set to the neural network as the plurality of pieces of training data, the supervised training data set including a plurality of pieces of supervised training data given annotation information;
acquiring first feature vectors that are the feature vectors output from the neural network by inputting the supervised training data set; and
deriving a value of a second loss function and a value of a fourth loss function, the value of the second loss function being derived based on the first feature vectors and representing a correlation between the annotation information given to the supervised training data set and output information obtained from the neural network by inputting the supervised training data set, the output information corresponding to the annotation information, the value of the fourth loss function being a value of the first loss function representing a correlation between channels in the first feature vectors, wherein
at the performing the learning, the learning of the neural network is performed so as to reduce the value of second loss function and the value of fourth loss function.

13. The computer program product to claim 9, further comprising
receiving an input of a learning condition including at least one of a network structure of the neural network as a target of the learning, the training data to be used in the learning, and a description of setting to be used at a time of the learning, wherein
at the performing the learning, the learning of the neural network is performed in accordance with the learning condition having been received.

14. The computer program product to claim 13, further comprising
displaying a display screen including at least one of a learning progress state of the neural network and a content of change recommendation for the learning condition depending on the learning progress state.

15. A learning apparatus comprising
one or more hardware processors configured to perform learning of a neural network so as to reduce a value of a first loss function representing a correlation between channels in feature vectors output from at least one of intermediate layers and a final layer in the neural network to which a plurality of pieces of training data has been input.

16. The apparatus according to claim 15, wherein the one or more hardware processors further configured to:
input a supervised training data set and an unsupervised training data set to the neural network as the plurality of pieces of training data, the supervised training data set including a plurality of pieces of supervised training data given annotation information, the unsupervised training data set including a plurality of pieces of unsupervised training data not given the annotation information;
acquire first feature vectors and second feature vectors, the first feature vectors being the feature vectors output from the neural network by inputting the supervised training data set, the second feature vectors being feature vectors output from the neural network by inputting the unsupervised training data set; and
derive a value of a second loss function and a value of a third loss function, the value of the second loss function being derived based on the first feature vector and representing a correlation between the annotation information given to the supervised training data set and output information obtained from the neural network by inputting the supervised training data set, the output information corresponding to the annotation information, the value of the third loss function being a value of the first loss function representing a correlation between channels in the second feature vectors, wherein
the one or more hardware processors performs the learning of the neural network so as to reduce the value of the second loss function and the value of the third loss function.

17. The apparatus according to claim 15, wherein the one or more hardware processors further configured to:
input a supervised training data set and an unsupervised training data set to the neural network as the plurality of pieces of training data, the supervised training data set including a plurality of pieces of supervised training data given annotation information, the unsupervised training data set including a plurality of pieces of unsupervised training data not given the annotation information;
acquire first feature vectors that are the feature vectors output from the neural network by inputting the supervised training data set and a second feature vectors that are the feature vectors output from the neural network by inputting the unsupervised training data set; and
derive a value of a second loss function, a value of a fourth loss function, and a value of a third loss function, the value of a second loss function being derived based on the first feature vectors and representing a correlation between the annotation information given to the supervised training data set and output information obtained from the neural network by inputting the supervised training data set, the output information corresponding to the annotation information, the value of the fourth loss function being a value of the first loss function representing a correlation between channels in the first feature vectors, the value of the third loss function being a value of the first loss function representing a correlation between channels in the second feature vectors, wherein
the one or more hardware processors performs the learning of the neural network so as to reduce the value of the second loss function, the value of the third loss function, and the value of the fourth loss function.

18. The apparatus according to claim 15, wherein the one or more hardware processors further configured to:
input a supervised training data set to the neural network as the plurality of pieces of training data, the supervised training data set including a plurality of pieces of supervised training data given annotation information;
acquire first feature vectors that are the feature vectors output from the neural network by inputting the supervised training data set; and
derive a value of a second loss function and a value of a fourth loss function, the value of the second loss function being derived based on the first feature vectors and representing a correlation between the annotation information given to the supervised training data set and output information obtained from the neural network by inputting the supervised training data set, the output information corresponding to the annotation information, the value of the fourth loss function being a value of the first loss function representing a correlation between channels in the first feature vectors, wherein
the one or more hardware processors performs the learning of the neural network so as to reduce the value of second loss function and the value of fourth loss function.

19. The apparatus according to claim 15, wherein the one or more hardware processors further configured to:
receive an input of a learning condition including at least one of a network structure of the neural network as a target of the learning, the training data to be used in the learning, and a description of setting to be used at a time of the learning, wherein
the one or more hardware processors performs the learning of the neural network in accordance with the learning condition having been received.

20. The apparatus according to claim 19, wherein the one or more hardware processors further configured to:
display a display screen including at least one of a learning progress state of the neural network and a content of change recommendation for the learning condition depending on the learning progress state.
